(19) United States
(12) Patent Application Publication
(10) Pub. No.: US 2024/0111827 A1
(43) Pub. Date: Apr. 4, 2024

(54) MATRIX DEVICE AND OPERATION METHOD THEREOF

(71) Applicant: NEUCHIPS CORPORATION, Hsinchu City (TW)

(72) Inventors: Huang-Chih Kuo, Hsinchu City (TW); YuShan Ruan, New Taipei City (TW); Jian-Wen Chen, Kaohsiung City (TW); Tzu-Jen Lo, Taipei City (TW)

(73) Assignee: NEUCHIPS CORPORATION, Hsinchu City (TW)

(21) Appl. No.: 17/978,989

(22) Filed: Nov. 2, 2022

(30) Foreign Application Priority Data
Sep. 20, 2022 (TW) 111135607

(51) Int. Cl. G06F 17/16; G06F 7/544; G06F 7/78

(52) U.S. Cl. CPC G06F 17/16; G06F 7/5443; G06F 7/78

(57) ABSTRACT

The present disclosure provides a matrix device and an operation method thereof. The matrix device includes a transpose circuit and a memory. The transpose circuit is configured to receive a first element string representing a native matrix from a matrix source, wherein all elements in the native matrix are arranged in the first element string in one of a “row-major manner” and a “column-major manner”. The transpose circuit transposes the first element string into a second element string, wherein the second element string is equivalent to an element string in which all elements of the native matrix are arranged in another one of the “row-major manner” and the “column-major manner”. The memory is coupled to the transpose circuit to receive the second element string.

### CROSS-REFERENCE TO RELATED APPLICATION

This application claims the priority benefit of Taiwan application serial no. 111135607, filed on Sep. 20, 2022. The entirety of the above-mentioned patent application is hereby incorporated by reference herein and made a part of this specification.

### BACKGROUND

### Technical Field

The present disclosure relates to a computing device, and more particularly, to a matrix device for matrix operation and an operation method thereof.

### Description of Related Art

Matrix multiplication is a fundamental operation in computer systems. After the operation circuit completes a previous matrix operation, different elements of the matrix (operation result) are sequentially written into a dynamic random access memory (DRAM) according to the generating sequence of the elements of the previous matrix operation. For example, matrices may be stored in DRAM in either a column-major manner or a row-major manner. However, the storage sequence of the matrix elements of the previous matrix operation in the DRAM might be unfavorable for the access of the next matrix operation. For example, the operation result matrix of the previous matrix operation is stored in the DRAM in a column-major manner for use of the next matrix operation, but the operand matrix of the next matrix operation is input in a row-major manner. Therefore, for the next matrix operation, the elements of the operand matrix are discretely placed in different positions (non-consecutive addresses) of the DRAM.

When the multiple elements accessed by the next matrix operation in the same batch are located at consecutive addresses in the DRAM, the operation circuit may use a burst read command to read these elements at consecutive addresses from the DRAM at one time. When the plurality of elements accessed by the next matrix operation are located at non-consecutive addresses of the DRAM, the operation circuit needs to use a plurality of read commands to read these elements from the DRAM multiple times. Generally speaking, the number of reads to DRAM is proportional to power consumption. How to appropriately store the matrix generated by the previous matrix operation in the DRAM so that the next matrix operation can efficiently access the matrix is an important issue. If the number of times of accessing the DRAM can be reduced in the process of accessing the matrix from the DRAM, the performance of the matrix operation may be effectively improved, and the power consumption of the circuit may be effectively reduced.

### SUMMARY

The present disclosure provides a matrix device and an operating method thereof to improve performance.

The present disclosure provides a matrix device including a transpose circuit and a memory. The transpose circuit is configured to receive a first element string representing a native matrix from a matrix source, and transpose the first element string into a second element string. All elements in the native matrix are arranged in the first element string in one of a “row-major manner” and a “column-major manner”. The second element string is equivalent to an element string in which all elements of the native matrix are arranged in the other one of the “row-major manner” and the “column-major manner”. The memory is coupled to the transpose circuit to receive the second element string.

In an embodiment of the present disclosure, the matrix device may be adopted in an operation, and the method includes: receiving, by a transpose circuit of the matrix device, a first element string representing a native matrix from a matrix source; transposing, by the transpose circuit, the first element string into a second element string, and all elements of the native matrix are arranged in the first element string in one of a “row-major manner” and a “column-major manner”, and the second element string is equivalent to an element string in which all elements of the native matrix are arranged in the other one of the “row-major manner” or the “column-major manner”; and receiving, by a memory of the matrix device, the second element string.

Based on the above, the transpose circuit in the embodiments of the present disclosure is able to make the arrangement of elements in the memory match the characteristics of access calculation through a transposing method. In this way, the efficiency of the matrix device may be effectively improved.

In order to make the above-mentioned features and advantages of the present disclosure more understandable, the following embodiments are given and described in detail with the accompanying drawings as follows.

### BRIEF DESCRIPTION OF THE DRAWINGS

FIG. 1 is a circuit block diagram of a matrix device according to an embodiment of the present disclosure.

FIG. 2 is a circuit block diagram of a matrix device according to another embodiment of the present disclosure.

FIG. 3 is a schematic diagram showing the storage positions of elements in a memory when the transpose circuit does not perform transposition.

FIG. 4 is a schematic diagram showing the storage positions of elements in the memory when the transpose circuit 210 performs transposition.

FIG. 5 is a schematic diagram of a storage method of elements in an SRAM (static random access memory).

FIG. 6 is a schematic flowchart of an operation method of a matrix device according to an embodiment of the present disclosure.

### DESCRIPTION OF THE EMBODIMENTS

A term “couple (or connect)” used in the full text of the disclosure (including the claims refers to any direct and indirect connections. For example, if a first device is described to be coupled to a second device, it is interpreted as that the first device is directly connected to the second device, or the first device is indirectly connected to the second device through other devices or connection means. Terms such as “first” and “second” mentioned in the full text of the description of the disclosure (including claims) are used to denote the names of elements, or to distinguish different embodiments or scopes, rather than to limit the upper or lower limit of the number of elements, nor is it intended to limit the order of the elements. Moreover, wherever possible, components/members/steps using the same referential numbers in the drawings and description refer to the same or like parts. Components/members/steps using the same referential numbers or using the same terms in different embodiments may cross-refer related descriptions.

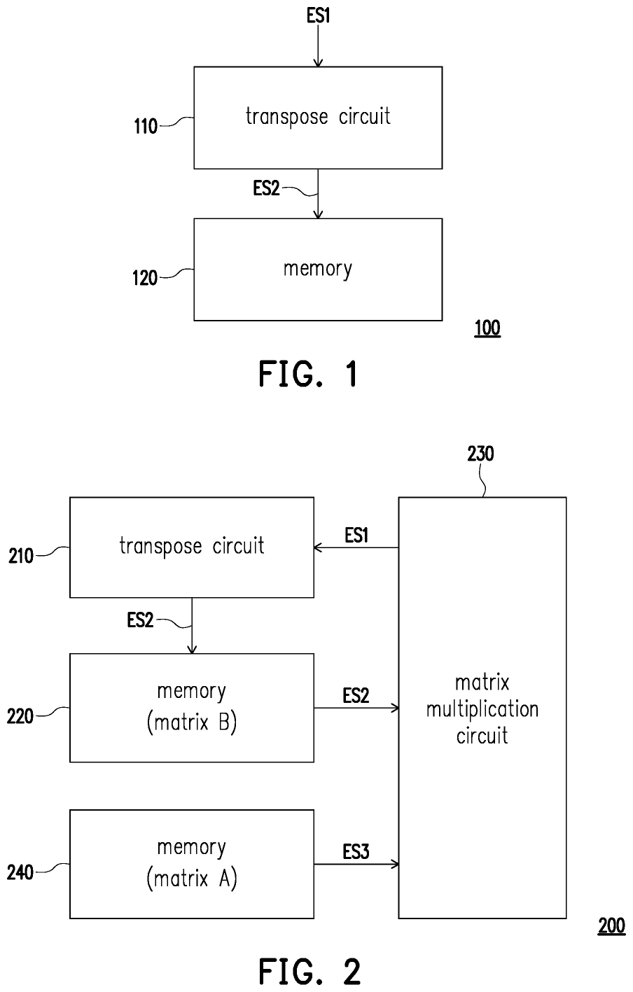

FIG. 1 is a circuit block diagram of a matrix device 100 according to an embodiment of the present disclosure. The matrix device 100 shown in FIG. 1 includes a transpose circuit 110 and a memory 120. According to different design requirements, in some embodiments, the transpose circuit 110 may be implemented as a hardware circuit. In other embodiments, the transpose circuit 110 may be implemented as firmware, software (that is, a program), or a combination of the two. In still other embodiments, the transpose circuit 110 may be implemented as a combination of hardware, firmware, and software.

In terms of hardware, the transpose circuit 110 may be implemented as a logic circuit on an integrated circuit. For example, the related functions of the transpose circuit 110 may be implemented in one or more controllers, microcontrollers, microprocessors, application-specific integrated circuits (ASICs), digital signal processor (DSP), field programmable gate array (FPGA) and/or various logic blocks, modules and circuits in other processing units. The related functions of the matrix device, transpose circuit and/or memory may be implemented as hardware circuits, such as various logic blocks, modules and circuits in an integrated circuit, using hardware description languages (such as Verilog HDL or VHDL) or other suitable programming languages.

In the form of software and/or firmware, the related functions of the transpose circuit 110 may be implemented as programming codes. For example, the transpose circuit 110 is implemented using general programming languages (e.g., C, C++, or assembly languages) or other suitable programming languages. The programming code may be recorded/stored in a “non-transitory computer readable medium”. In some embodiments, the non-transitory computer readable medium includes, for example, semiconductor memory and/or storage devices. The semiconductor memory includes a memory card, a read only memory (ROM), a flash memory, a programmable logic circuit or other semiconductor memories. The storage device includes tape, disk, hard disk drive (HDD), solid-state drive (SSD), or other storage devices. An electronic device (such as a central processing unit (CPU), controller, microcontroller, or microprocessor) may read and execute the programming code from the non-transitory computer readable medium, thereby realizing related functions of the transpose circuit 110.

The transpose circuit 110 may receive, from a matrix source (not shown in FIG. 1), an element string ES1 representing a native matrix. The present embodiment does not limit the matrix source. For example, in some embodiments, the matrix source may include a storage device, a network, a matrix multiplication circuit, or other source for providing an operand matrix. In some embodiments, the matrix multiplication circuit may include a multiply accumulate (MAC) array.

The transpose circuit 110 may transpose the element string ES1 to the element string ES2, and all elements of a native matrix are arranged in the element string ES1 in one of a “row-major manner” and a “column-major manner”, and the element string ES2 is equivalent to an element string in which all elements of the native matrix are arranged in the other one of the “row-major manner” and the “column-major manner”. For example, it is assumed that the content of the native matrix A is as shown in Equation 1 below. The content of the element string ES1 of the native matrix A arranged in the “row-major manner” is {X00, X01, X10, X11}. After the transposing function of the transpose circuit 110, the native matrix A is transposed into the element string ES2 arranged in the “column-major manner”, and the content of the element string ES2 is {X00, X10, X01, X11}.

$$A = [ \begin{matrix}{X}_{00} & {X}_{01} \\ {X}_{10} & {X}_{11}\end{matrix} ] \qquad Equation 1$$

The memory 120 is coupled to the transpose circuit 110. The transpose circuit 110 transmits the element string ES2 obtained by transposing the element string ES1 of the native matrix A to the memory 120. According to the actual design, the memory 120 may be any kind of memory. For example, in some embodiments, the memory 120 may be static random access memory (SRAM), dynamic random access memory (DRAM), magnetic random access memory (MRAM), magnetoresistive random access memory (MRAM), flash memory, or other memories. The memory 120 receives and stores the element string ES2 as an operand matrix for the next matrix operation.

For example, FIG. 2 is a circuit block diagram of the matrix device 200 according to another embodiment of the present disclosure. The matrix device 200 shown in FIG. 2 includes a transpose circuit 210, a memory 220, a matrix multiplication circuit 230, and a memory 240. The matrix device 200, the transpose circuit 210 and the memory 220 shown in FIG. 2 may be deduced from the description of the matrix device 100, the transpose circuit 110 and the memory 120 shown in FIG. 1, so no more details are repeated here. The matrix device 200 shown in FIG. 2 may be used as one of many implementation examples of the matrix device 100 shown in FIG. 1. Therefore, the matrix device 100, the transpose circuit 110 and the memory 120 shown in FIG. 1 may be cross-related to the description of the matrix device 200, the transpose circuit 210, and the memory 220 shown in FIG. 2.

The matrix multiplication circuit 230 is coupled to the transpose circuit 210, the memory 220 and the memory 240. The matrix multiplication circuit 230 may perform a previous layer of calculation of neural network calculations to generate native matrices. The matrix multiplication circuit 230 may serve as a matrix source to provide the element string ES1 of the native matrix to the transpose circuit 210. The transpose circuit 210 may transpose the element string ES1 to the element string ES2. The memory 220 is coupled to the transpose circuit 210 to receive and store the element string ES2. The matrix multiplication circuit 230 may read the element string ES3 (matrix A) from the memory 240 as a weight matrix, and read the element string ES2 (matrix B) from the memory 220 as an input matrix, so as to perform a next layer of calculation in the neural network calculation. In general, weight matrices are pre-trained parameters.

For example, assume that memory 220 includes a DRAM. Based on the transpose operation of the transpose circuit 210, all elements of the same column of the native matrix (the result of the previous layer of calculation) may be stored in multiple consecutive addresses in the memory 220. The memory 220 provides all elements of the same column of the native matrix to the matrix multiplication circuit 230 in a burst mode, so that the matrix multiplication circuit 230 performs the next layer of calculation of the neural network calculation.

This embodiment provides no limitation to the matrix operation of the matrix multiplication circuit 230. In some application examples, the matrix operations may include matrix addition operations, matrix multiplication operations, multiply-accumulate (MAC) operations, and/or other matrix operations. For example, it is assumed that the content of the native matrix A is shown in Equation 1 above, and the content of the native matrix B is shown in Equation 2 below. A matrix Z is obtained by multiplying two 2×2 matrices A and B, as shown in Equation 3 below.

$$B = [ \begin{matrix}{Y}_{00} & {Y}_{01} \\ {Y}_{10} & {Y}_{11}\end{matrix} ] \qquad Equation 2$$

$$A \times B = Z = [ \begin{matrix}{X}_{00} {Y}_{00} + & {X}_{01} {Y}_{10} & {X}_{00} {Y}_{01} + & {X}_{01} {Y}_{11} \\ {X}_{10} {Y}_{00} + & {X}_{11} {Y}_{10} & {X}_{10} {Y}_{01} + & {X}_{11} {Y}_{11}\end{matrix} ] \qquad Equation 3$$

The matrix multiplication performed by the matrix multiplication circuit 230 may include four steps. Step 1: The matrix multiplication circuit 230 may extract the elements [X₀₀, X₀₁] of the matrix A from the memory 240, extract the elements [Y₀₀, Y₁₀] of the matrix B from the memory 220, and calculate X₀₀Y₀₀+X₀₁Y₁₀. Step 2: The matrix multiplication circuit 230 may retain the elements [X₀₀, X₀₁] of the matrix A, extract the elements [Y₀₁, Y₁₁] of the matrix B from the memory 220, and calculate X₀₀Y₀₁+X₀₁Y₁₁. Step 3: The matrix multiplication circuit 230 may extract the elements [X₁₀, X₁₁] of the matrix A from the memory 240, extract the elements [Y₀₀, Y₁₀] of the matrix B from the memory 220, and calculate X₁₀Y₀₀+X₁₁Y₁₀. Step 4: The matrix multiplication circuit 230 may retain the elements [X₁₀, X₁₁] of the matrix A, extract the elements [Y₀₁, Y₁₁] of the matrix B from the memory 220, and calculate X₁₀Y₀₁+X₁₁Y₁₁. At this stage, the matrix multiplication circuit 230 may obtain the matrix Z shown in Equation 3.

The matrix multiplication performed by the matrix multiplication circuit 230 described in the preceding paragraph includes four steps, and the memory 220 is read six times. If the calculation is performed on the principle of data reuse, matrix multiplication may be reduced from four steps to two optimized steps. Optimized step 1: The matrix multiplication circuit 230 may extract the elements [X₀₀, X₁₀] of the matrix A from the memory 240, extract the elements [Y₀₀, Y₀₁] of the matrix B from the memory 220, and calculate X₀₀Y₀₀, X₀₀Y₀₁, X₁₀Y₀₀ and X₁₀Y₀₁. Optimized step 2: The matrix multiplication circuit 230 may extract the elements [X₀₁, X₁₁] of the matrix A from the memory 240, extract the elements [Y₁₀, Y₁₁] of the matrix B from the memory 220, and calculate X₀₁Y₀₁, X₀₁Y₁₁, X₁₁Y₁₀, X₁₁Y₁₁. At this stage, the matrix multiplication circuit 230 may obtain the matrix Z shown in Equation 3 using X₀₀Y₀₀, X₀₀Y₀₁, X₁₀Y₀₀, X₁₀Y₀₁, X₀₁Y₀₁, X₁₁Y₁₁, X₁₁Y₁₀, X₁₁Y₁₁ in the optimized step 1 and optimized step 2.

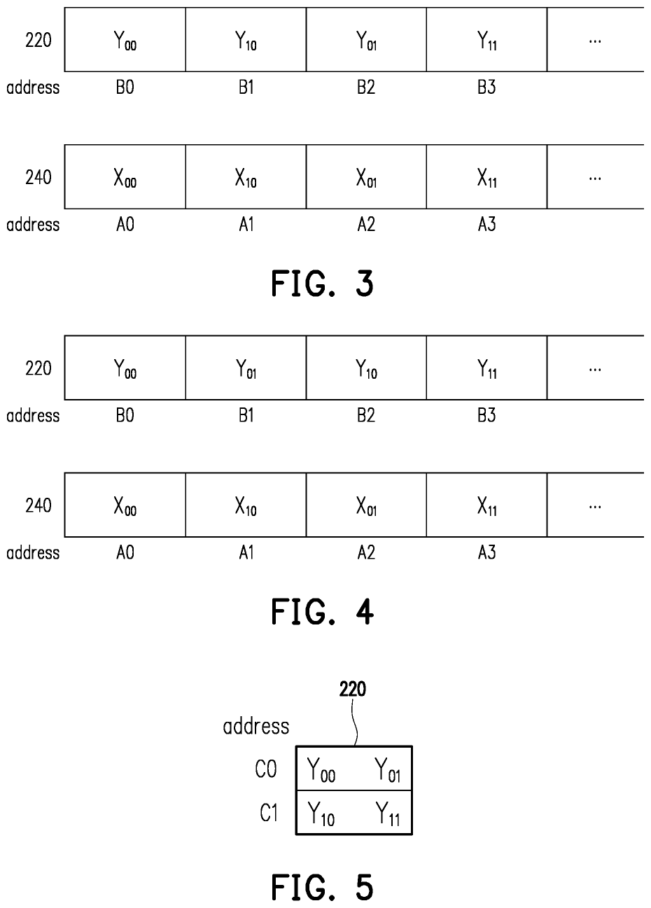

As a comparison with FIG. 4, FIG. 3 shows the storage positions of the elements in the memories 220 and 240 when the transpose circuit 210 does not perform transposition (that is, the element string ES2 is the same as the element string ES1). It is assumed here that the matrix A is stored in the memory 240 in a column-major manner, and all elements of the matrix B are also arranged in the element string ES1 in a column-major manner. That is, the matrix B is stored in the memory 220 in a column-major manner. In the optimized step 1, the matrix multiplication circuit 230 may extract the elements [X₀₀, X₁₀] of the matrix A from the consecutive addresses A0 and A1 of the memory 240 in a burst mode. Because the elements [Y₀₀, Y₀₁] of the matrix B are located at discrete addresses (non-consecutive addresses) B0 and B2 of the memory 220, extraction cannot be performed in the burst mode. Therefore, the matrix multiplication circuit 230 extracts the element [Y₀₀] and the element [Y₀₁] from the memory 220 separately. In the optimized step 2, the matrix multiplication circuit 230 may extract the elements [X₀₁, X₁₁] of the matrix A from the consecutive addresses A2 and A3 of the memory 240 in a burst mode. Because the elements [Y₁₀, Y₁₁] of the matrix B are located at discrete addresses (non-consecutive addresses) B1 and B3 of the memory 220, extraction cannot be performed in the burst mode. Therefore, the matrix multiplication circuit 230 extracts the element [Y₁₀] and the element [Y₁₁] from the memory 220 separately.

FIG. 4 is a schematic diagram showing the storage positions of elements in the memories 220 and 240 when the transpose circuit 210 performs transposition. It is assumed here that the matrix A is stored in the memory 240 in a column-major manner, and all elements of the matrix B are also arranged in the element string ES1 in a column-major manner. Based on the transposing operation of the transpose circuit 210, the element string ES2 is equivalent to an element string in which all elements of the native matrix B are arranged in a row-major manner. The element string ES2 is sequentially and consecutively stored in the memory 220. That is, the matrix B is stored in the memory 220 in a row-major manner, as shown in FIG. 4. In the optimized step 1, the matrix multiplication circuit 230 may extract the elements [X₀₀, X₁₀] of the matrix A from the consecutive addresses A0 and A1 of the memory 240 in a burst mode, and extract the elements [Y₀₀, Y₀₁] of the matrix B from consecutive addresses B0 and B1 of the memory 220 in the burst mode. In the optimized step 2, the matrix multiplication circuit 230 may extract the elements [X₀₁, X₁₁] of the matrix A from the consecutive addresses A2 and A3 of the memory 240 in the burst mode, and extract the elements [Y₁₀, Y₁₁] of the matrix B from the consecutive addresses B2 and B3 of the memory 220 in the burst mode.

FIG. 5 is a schematic diagram of an element storage method in an SRAM. In the embodiment shown in FIG. 5, the memory 220 may be a piece of SRAM, and the SRAM has a depth of 2 (two addresses) and a data width of 2 (two elements). It is assumed here that all elements of the matrix B are arranged in the element string ES1 in a column-major manner. Based on the transposing operation of the transpose circuit 210, all elements of the matrix B are arranged in the element string ES2 in a row-major manner. That is, the matrix B is stored in the memory 220 (SRAM) in a row-major manner, as shown in FIG. 5. In the optimized step 1, the matrix multiplication circuit 230 may extract the elements [X₀₀, X₁₀] of the matrix A from the consecutive addresses of the memory 240 (e.g., DRAM), and extract the elements [Y₀₀, Y₀₁] of the matrix B from the address C0 of the memory 220 (SRAM) in the burst mode. In the optimized step 2, the matrix multiplication circuit 230 may extract elements [X₀₁, X₁₁] of matrix A from consecutive addresses in the memory 240 (DRAM), and extract elements [Y₁₀, Y₁₁] of the matrix B from the address C1 of the memory 220 (SRAM) in the burst mode.

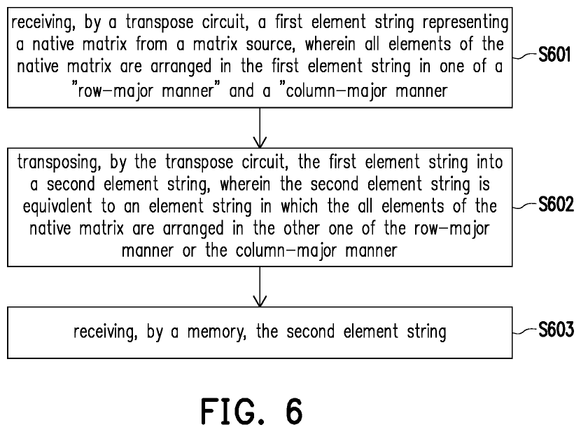

FIG. 6 is a schematic flowchart of an operation method of a matrix device according to an embodiment of the present disclosure. Please refer to FIG. 1 and FIG. 6. In step S601, the transpose circuit 110 of the matrix device 100 receives an element string ES1 (first element string) representing the native matrix from the matrix source, and all elements of the native matrix are arranged in the element string ES1 in one of a “row-major manner” and a “column-major manner”. In step S602, the transpose circuit 110 may transpose the element string ES1 into the element string ES2 (second element string), and the element string ES2 is equivalent to an element string in which all elements of the native matrix are arranged in the other one of the “row-major manner” and the “column-major manner”. In step S603, the memory 120 of the matrix device 100 receives and stores the element string ES2 as the operand matrix for the next matrix operation.

To sum up, the transpose circuit in the embodiments of the present disclosure is able to make the arrangement of elements in the memory match the characteristics of access calculation through a transposing method. In this way, the matrix device may reduce the energy consumption and time required for accessing and reading the memory, thereby effectively improving the efficiency of the matrix device.

Although the present disclosure has been disclosed in the above embodiments, it is not intended to limit the present disclosure, and those skilled in the art can make some modifications and refinements without departing from the spirit and scope of the disclosure. Therefore, the scope to be protected by the present disclosure is subject to the scope defined by the appended claims.

What is claimed is:

1. A matrix device, comprising:
a transpose circuit, configured to receive a first element string representing a native matrix from a matrix source, and transpose the first element string into a second element string, wherein all elements in the native matrix are arranged in the first element string in one of a row-major manner and a column-major manner, and the second element string is equivalent to an element string in which the all elements of the native matrix are arranged in the other one of the row-major manner and the column-major manner; and
a memory, coupled to the transpose circuit to receive the second element string.

2. The matrix device of claim 1, wherein the matrix source comprises a storage device, a network, or a matrix multiplication circuit.

3. The matrix device of claim 2, wherein the matrix multiplication circuit comprises a multiply accumulate (MAC) array.

4. The matrix device of claim 1, further comprising:
a matrix multiplication circuit coupled to the transpose circuit and the memory, wherein the matrix multiplication circuit performs a previous layer of calculation of a neural network calculation to generate the native matrix, and the matrix multiplication circuit serves as the matrix source to provide the first element string of the native matrix to the transpose circuit, and the matrix multiplication circuit reads the second element string from the memory to perform a next layer of calculation of the neural network calculation.

5. The matrix device of claim 4, wherein the memory comprises a dynamic random access memory, and the memory provides the all elements of a column of the native matrix to the matrix multiplication circuit in a burst mode to perform the next layer of calculation of the neural network calculation.

6. The matrix device of claim 5, wherein the all elements of the one column of the native matrix are stored at a plurality of consecutive addresses in the memory.

7. The matrix device of claim 1, wherein the all elements of the native matrix are arranged in the first element string in the column-major manner, the second element string is equivalent to an element string in which the all elements of the native matrix are arranged in the row-major manner, and the second element string is sequentially and consecutively stored in the memory.

8. An operation method of a matrix device, comprising:
receiving, by a transpose circuit of the matrix device, a first element string representing a native matrix from a matrix source;
transposing, by the transpose circuit, the first element string into a second element string, wherein all elements of the native matrix are arranged in the first element string in one of a row-major manner and a column-major manner, and the second element string is equivalent to an element string in which the all elements of the native matrix are arranged in the other one of the row-major manner or the column-major manner; and
receiving, by a memory of the matrix device, the second element string.

9. The operation method of claim 8, wherein the matrix source comprises a storage device, a network, or a matrix multiplication circuit.

10. The operation method of claim 9, wherein the matrix multiplication circuit comprises an MAC array.

11. The operation method of claim 8, further comprising:
performing, by a matrix multiplication circuit of the matrix device, a previous layer of calculation of a neural network calculation to generate the native matrix, and the matrix multiplication circuit serves as the matrix source to provide the first element string of the native matrix to the transpose circuit, and
reading, by the matrix multiplication circuit, the second element string from the memory to perform a next layer of calculation of the neural network calculation.

12. The operation method of claim 11, wherein the memory comprises a dynamic random access memory, and the operation method further comprises:
providing, by the memory, the all elements of a column of the native matrix to the matrix multiplication circuit in a burst mode to perform the next layer of calculation of the neural network calculation.

13. The operation method of claim 12, wherein the all elements of the one column of the native matrix are stored at a plurality of consecutive addresses in the memory.

14. The operation method of claim 8, wherein the all elements of the native matrix are arranged in the first element string in the column-major manner, the second element string is equivalent to an element string in which the all elements of the native matrix are arranged in the row-major manner, and the second element string is sequentially and consecutively stored in the memory.
